(19) United States
(12) Patent Application Publication
(10) Pub. No.: US 2009/0135130 A1
(43) Pub. Date: May 28, 2009

(54) ELECTROPHORETIC SHEET, ELECTROPHORETIC DISPLAY DEVICE INCLUDING THE SAME, AND METHOD OF MANUFACTURING THE SAME

(75) Inventor: Woo-Jae LEE, Yongin-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/026,529

(22) Filed: Feb. 5, 2008

(30) Foreign Application Priority Data
Nov. 27, 2007 (KR) 10-2007-0121273

(51) Int. Cl. G09G 3/34; H01J 9/00

(52) U.S. Cl. 345/107; 445/46

(57) ABSTRACT

A method of manufacturing an electrophoretic sheet includes forming a first adhesive layer on a first release sheet, forming a second adhesive layer on a second release sheet, forming an electrophoretic layer on one side of the first adhesive layer, and coupling the electrophoretic layer to the second adhesive layer.

### CROSS-REFERENCE TO RELATED APPLICATION

This application claims priority from and the benefit of Korean Patent Application No. 10-2007-0121273, filed on Nov. 27, 2007, which is hereby incorporated by reference for all purposes as if fully set forth herein.

### BACKGROUND OF THE INVENTION

1. Field of the Invention

The present invention relates to an electrophoretic sheet, an electrophoretic display device including the same, and a method of manufacturing the same.

2. Discussion of the Background

An electrophoretic display device is a display device for displaying information. The electrophoretic display device has high reflectivity and a high contrast ratio. Since the image displayed by an electrophoretic display device may not vary at different viewing angles, viewers feel comfortable, as if they are viewing a piece of paper. Furthermore, since the electrophoretic display device may not require a polarizer, an alignment layer, or liquid crystal as opposed to a liquid crystal display (“LCD”) device, it may have competitive manufacturing costs.

A conventional electrophoretic display device may include an electrophoretic layer and a color filter disposed on the electrophoretic layer to display various colors. The electrophoretic layer may include capsules, which are filled with black and white pigment particles, and a binder.

The electrophoretic layer of the electrophoretic display device may be formed by coating the capsules and the binder on a substrate. However, if electrophoretic layer is not uniformly coated, color gamut may be reduced and parts may be coated unnecessarily. Therefore, a process of removing the unnecessary coating may be required, which may increase manufacturing costs and time.

### SUMMARY OF THE INVENTION

The present invention provides an electrophoretic sheet, an electrophoretic display device including the same, and a method of manufacturing the same, wherein an electrophoretic layer is uniformly coated on a release plate.

Additional features of the invention will be set forth in the description which follows, and in part will be apparent from the description, or may be learned by practice of the invention.

The present invention discloses a method of manufacturing an electrophoretic sheet including forming a first adhesive layer on a first release sheet, forming a second adhesive layer on a second release sheet, forming an electrophoretic layer on one side of the first adhesive layer, and coupling the electrophoretic layer to the second adhesive layer.

The present invention also discloses a method of manufacturing an electrophoretic display device including forming a first adhesive layer on a first release sheet, forming a second adhesive layer on a second release sheet, forming an electrophoretic layer on one side of the first adhesive layer, coupling the electrophoretic layer to the second adhesive layer to form an electrophoretic sheet, and arranging the electrophoretic sheet between a thin film transistor substrate and a color filter substrate.

The present invention also discloses an electrophoretic sheet including an electrophoretic layer including black and white charge pigment particles, first and second adhesive layers arranged at first and second surfaces of the electrophoretic layer, respectively, and first and second release sheets attached to the first and second adhesive layers, respectively.

The present invention also discloses an electrophoretic display device including a thin film transistor substrate including a thin film transistor and a pixel electrode, a color filter substrate facing the thin film transistor substrate and including a color filter and a common electrode, and an electrophoretic layer disposed between the thin film transistor substrate and the color filter substrate. The electrophoretic layer includes a capsule filled with black and white charged pigment particles and is disposed between the thin film transistor substrate and the color filter substrate and between first and second adhesive layers arranged at opposite sides of the electrophoretic layer.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention are incorporated in and constitute a part of this specification, illustrate embodiments of the invention, and together with the description serve to explain the principles of the invention.

FIG. 1 is a view of an electrophoretic sheet according to an exemplary embodiment of the present invention.

FIG. 2 is a view of an electrophoretic display device according to an exemplary embodiment of the present invention.

FIG. 3 is a flowchart showing a process of manufacturing an electrophoretic sheet and an electrophoretic display device including the electrophoretic sheet according to an exemplary embodiment of the present invention.

FIG. 4A, FIG. 4B, FIG. 4C, and FIG. 4D are views showing a manufacturing process of an electrophoretic sheet according to an exemplary embodiment of the present invention.

FIG. 4E, FIG. 4F, FIG. 4G, FIG. 4H, FIG. 4I, and FIG. 4J are views showing a manufacturing process of an electrophoretic display device according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative size of layers and regions may be exaggerated for clarity. Like reference numerals in the drawings denote like elements.

It will be understood that when an element such as a layer, film, region or substrate is referred to as being “on”, “connected to”, or “coupled to” another element or layer, it can be directly on, directly connected to, or directly coupled to the other element or layer, or intervening elements or layers may also be present. In contrast, when an element is referred to as being “directly on”, “directly connected to”, or “directly coupled to” another element or layer, there are no intervening elements or layers present.

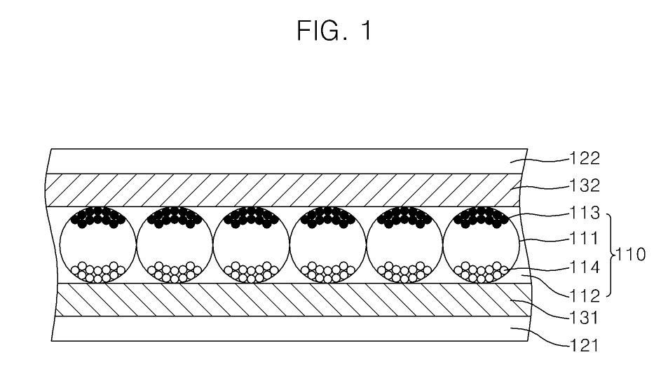

FIG. 1 is a view for explaining an electrophoretic sheet according to an exemplary embodiment of the present invention.

Referring to FIG. 1, an electrophoretic sheet according to an exemplary embodiment of the present invention includes a first adhesive layer 131 formed on a lower surface of an electrophoretic layer 110, a second adhesive layer 132 formed on an upper surface of the electrophoretic layer 110, a first release sheet 121 to protect the first adhesive layer 131, and a second release sheet 122 to protect the second adhesive layer 132.

The electrophoretic layer 110 includes capsules 111, which are each filled with black and white pigment particles 113 and 114, and a binder 112 to protect and fix the position of the capsules 111. The black pigment particles 113 have positive polarity and the white pigment particles 114 have negative polarity. The binder 112 encompasses the capsules 111.

The electrophoretic layer 110 may include a twist ball of black and white color and may also include oil.

The first and second adhesive layers 131 and 132 may be transparent and may have low electric conductivity. For example, the first and second adhesive layers 131 and 132 may include a typical acrylic- or epoxy-based adhesive.

The first and second release sheets 121 and 122 may include a flexible material, such as plastic. For example, the first and second release sheets 121 and 122 may include polyethylene (PE), polyethylene terephthalate (PET), or polyethylene naphthalate (PEN) with a prescribed size or may be an elongated tape. The first and second release sheets 121 and 122 are attached to the first and second adhesive layers 131 and 132, respectively. The first and second release sheets 121 and 122 protect the surfaces of the first and second adhesive layers 131 and 132. When the first and second release sheets 121 and 122 are attached to materials other than the first and second adhesive layers 131 and 132, the first and second release sheets 121 and 122 may be detached from the first and second adhesive layers 131 and 132.

The electrophoretic sheet may have a prescribed size having a unit area or may be in the shape of a tape wound onto a reel. When the first and second release sheets 121 and 122 are detached from the first and second adhesive layers 131 and 132, the electrophoretic sheet may be easily attached to other materials using the exposed adhesive layers 131 and 132.

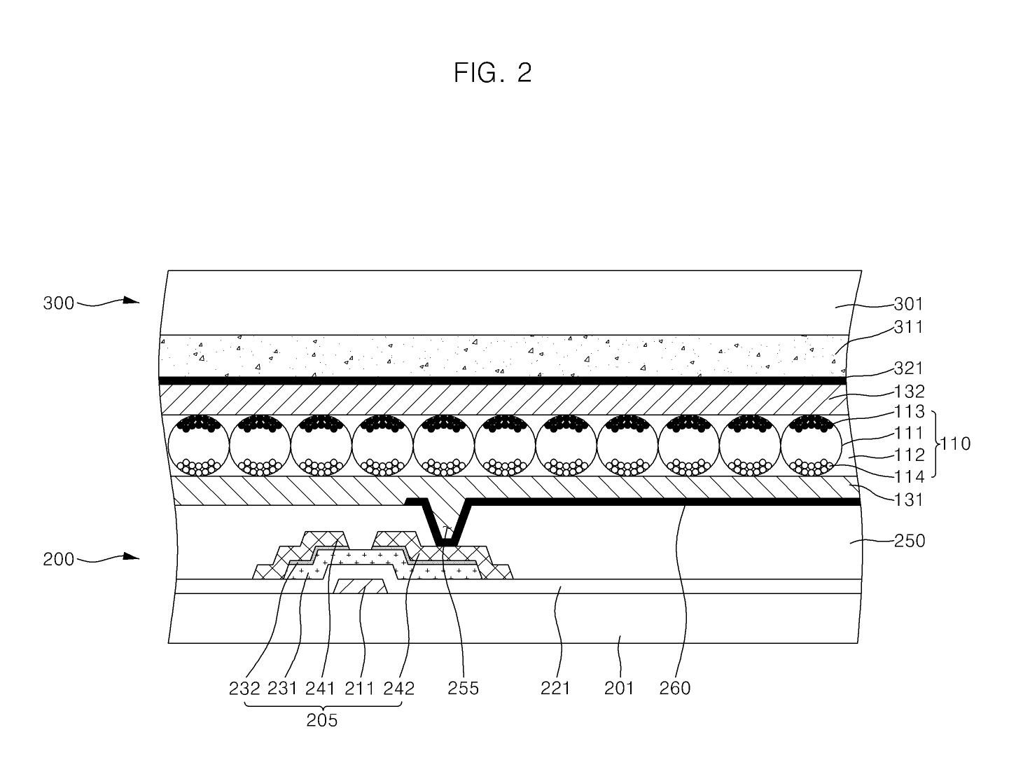

FIG. 2 is a view of an electrophoretic display device according to an exemplary embodiment of the present invention.

The electrophoretic display device according to an exemplary embodiment of the present invention includes a thin film transistor (“TFT”) substrate 200, a color filter substrate 300, and an electrophoretic layer 110 disposed between the TFT substrate 200 and the color filter 300.

The TFT substrate 200 includes a TFT 205 formed on a lower plate 201 and a pixel electrode 260 connected to the TFT 205.

The lower plate 201 may include a thin layer of glass or plastic material.

The TFT 205 includes a gate electrode 211 to which a gate voltage is supplied, a source electrode 241 to which a data voltage is supplied, a drain electrode 242 connected to the pixel electrode 260, and an active layer 231 forming a channel between the source electrode 241 and the drain electrode 242 on a gate insulating layer 221. The TFT 205 also includes an ohmic contact layer 232 that contacts the source electrode 241 and the drain electrode 242 on the active layer 231.

The pixel electrode 260 is connected to the drain electrode 242 through a contact hole 255. The contact hole 255 penetrates a protective layer 250, which protects the TFT 205, and exposes a part of the drain electrode 242.

A color filter substrate 300 includes a color filter 311 and a common electrode 321 disposed on an upper plate 301. The upper plate 301 may include a transparent flexible material, such as plastic. The color filter 311 may include pigments to display red, green, and blue on the upper plate 301. The common electrode 321 may include a transparent conductive material, such as indium tin oxide (ITO) or indium zinc oxide (IZO), on the color filter 311.

The electrophoretic layer 110 includes capsules 111, which are each filled with black and white charged pigment particles 113 and 114, and a binder 112 to protect and fix the position of the capsules 111. The electrophoretic layer 110 is attached to the TFT substrate 200 and the color filter substrate 300 through first and second adhesive layers 131 and 132, respectively. The first and second adhesive layers 131 and 132 are arranged at the lower and upper surfaces of the electrophoretic layer 110, respectively, may be transparent, and may have low electric conductivity.

The electrophoretic layer 110 may include a twist ball of black and white color and may also include oil.

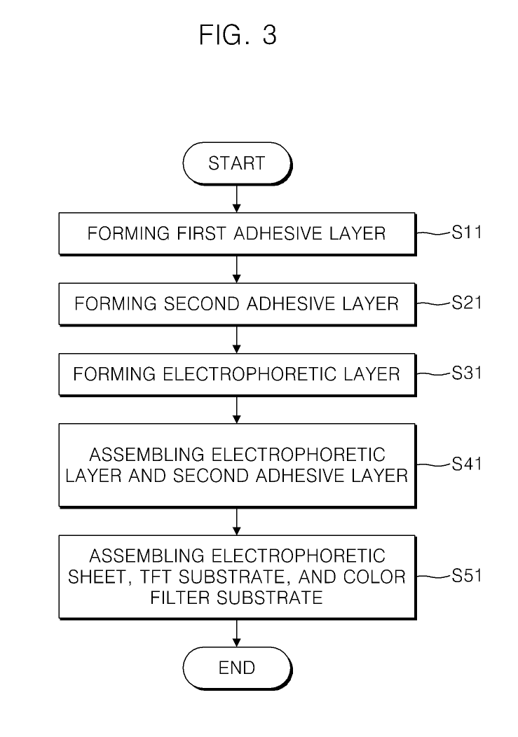

FIG. 3 is a flowchart showing a process of manufacturing an electrophoretic sheet and an electrophoretic display device including the electrophoretic sheet according to an exemplary embodiment of the present invention.

Referring to FIG. 3, an electrophoretic sheet manufacturing process includes forming a first adhesive layer at an upper surface of a first release sheet (S11), forming a second adhesive layer at an upper surface of a second release sheet (S21), forming an electrophoretic layer on the first adhesive layer (S31), assembling the electrophoretic layer and the second adhesive layer (S41), and assembling the electrophoretic sheet, the TFT substrate, and the color filter substrate (S51).

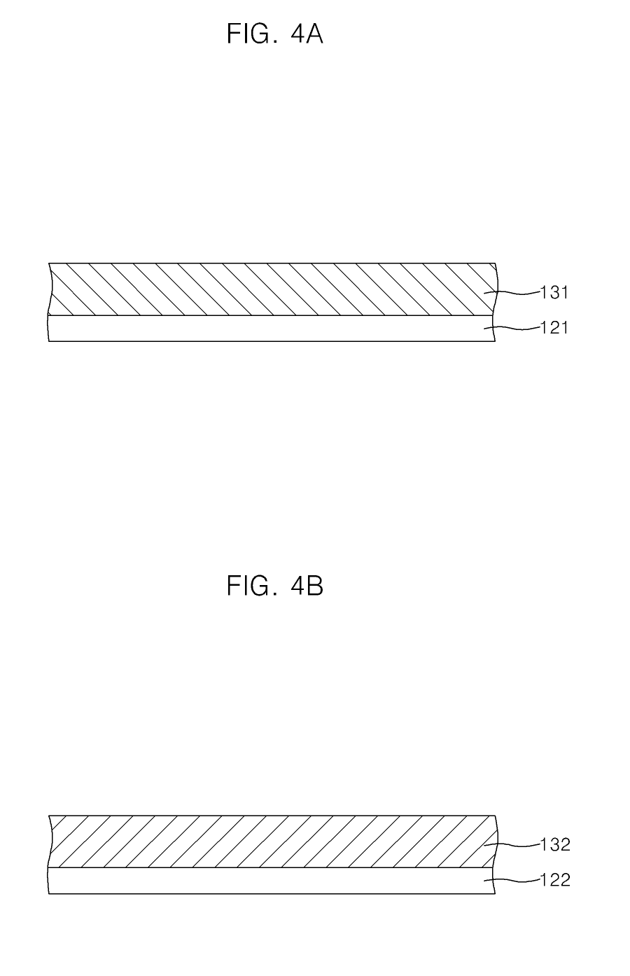

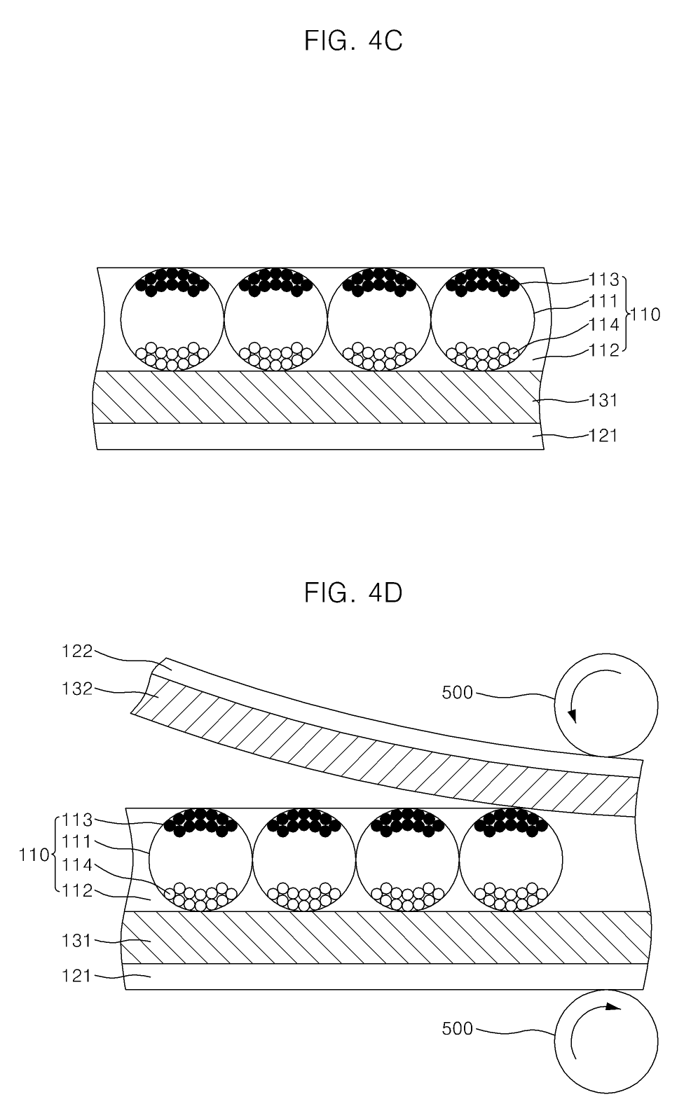

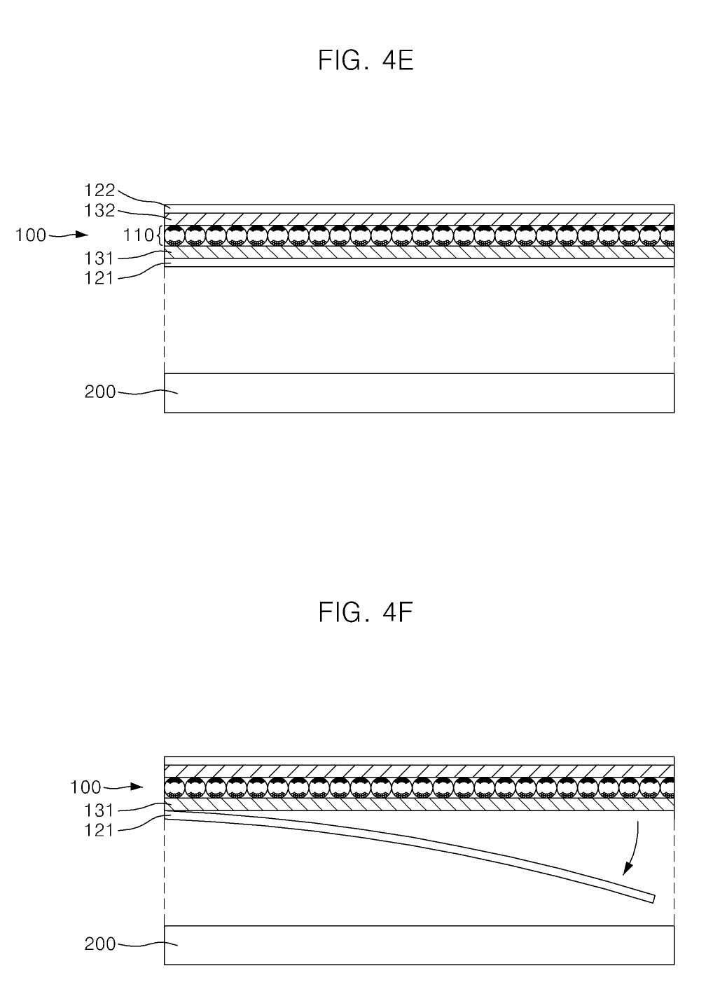

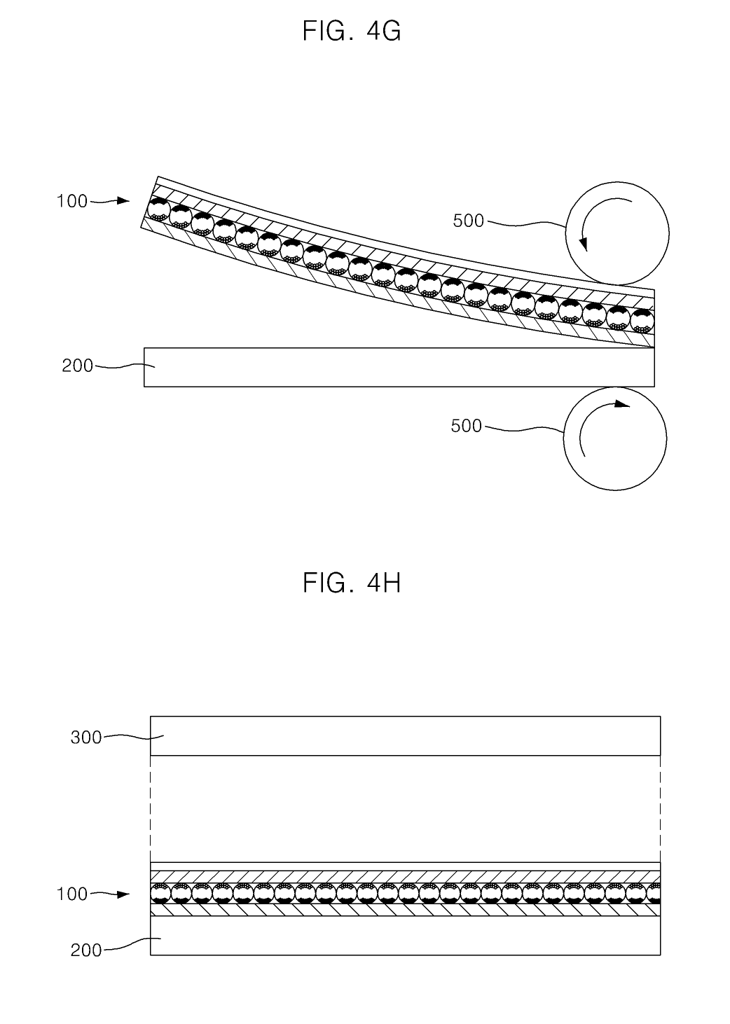

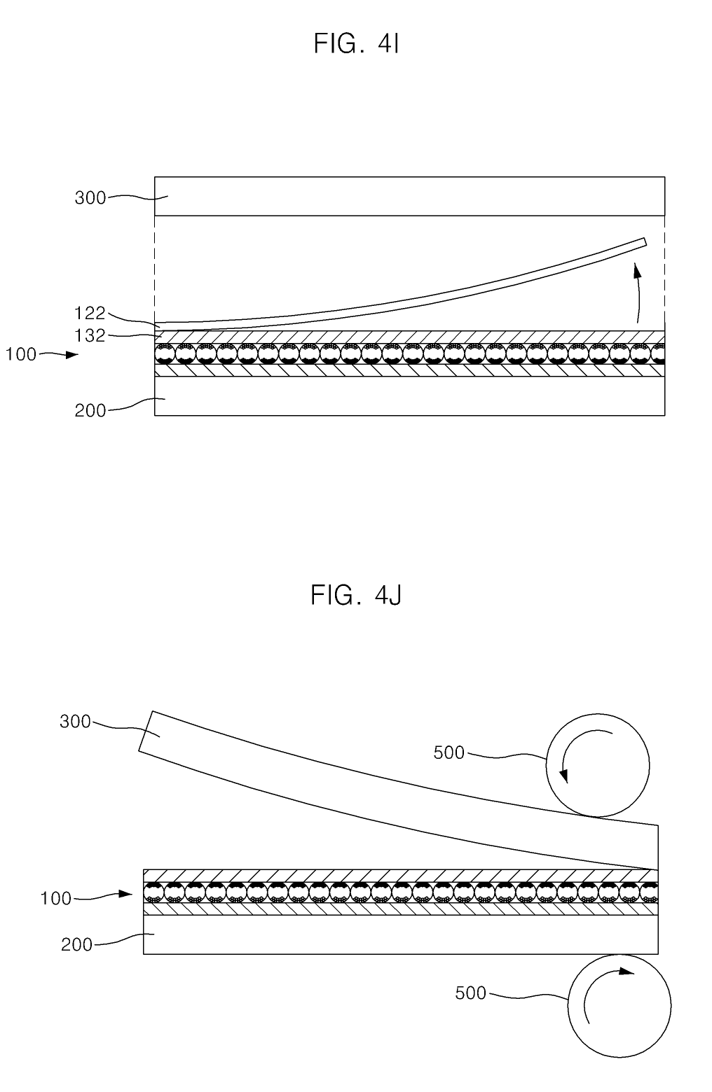

FIG. 4A, FIG. 4B, FIG. 4C, and FIG. 4D are views showing a manufacturing process of the electrophoretic according to an exemplary embodiment of the present invention.

FIG. 4A shows a process of forming a first adhesive layer 131 (S11 shown in FIG. 3). A first release sheet 121 including a plastic material, such as polyethylene (PE), polyethylene terephthalate (PET), or polyethylene naphthalate (PEN), is prepared. The first release sheet 121 is formed to have a prescribed size or an elongated tape shape. Next, an acrylic- or epoxy-based adhesive that is transparent and has low electric conductivity is deposited on the first release sheet 121. The adhesive is cured using heat or ultraviolet rays to form a first adhesive layer 131. For example, the first release sheet 121 coated with the adhesive may be heated using an oven heated to a temperature in the range of about 120° C. to about 140° C. to cure the adhesive. Alternatively, the adhesive may be cured by irradiating ultraviolet rays onto the adhesive coated on the first release sheet 121. Curing the adhesive by heat or ultraviolet rays may be optionally applied according to components of the adhesive. The adhesive is appropriately cured so that elasticity and adhesiveness may be maintained.

FIG. 4B shows a process of forming a second adhesive layer 132 (S21 shown in FIG. 3). A second release sheet 122 is prepared. An adhesive is coated on the second sheet 122 and cured to form a second adhesive layer 132. The second release sheet 122 may be of the same material and have the same size as the first release sheet 121. The adhesive is appropriately cured by heat or ultraviolet rays, similar to that described above with regard to FIG. 4A, so that elasticity and adhesiveness can be maintained.

FIG. 4C shows a process of forming an electrophoretic layer 110 (S31 shown in FIG. 3). Capsules 111, which are filled with black and white charged pigment particles 113 and 114, and a binder 112 are coated on the first adhesive layer 131. The capsules 111 are coated uniformly. The capsules 111 and the binder 112 are cured by heat or ultraviolet rays. The humidity of the capsules 111 may be about 50% in consideration of mobility of the charged pigment particles 113 and 114. The capsules 111 may be coated in a single layer structure.

FIG. 4D shows a process (S41 shown in FIG. 3) of assembling the electrophoretic layer and the second adhesive layer. The second adhesive layer 132, which is disposed on the second release sheet 122, is positioned at the upper surface of the electrophoretic layer 110. Next, the electrophoretic layer 110 and the second adhesive layer 132 may be laminated. Namely, rollers 500 are arranged at surfaces of the first and second release sheets 121 and 122, on which the first and second adhesive layers 131 and 132 are not disposed, to perform roll-to-roll lamination. When the first and second release sheets 121 and 122 have a prescribed size, the first and second release sheets 121 and 122 may be vacuum laminated in a vacuum chamber.

The size of the laminated electrophoretic sheet is adjusted according to the size of the TFT substrate and the color filter substrate. For example, the electrophoretic sheet may be cut to a size corresponding to a display area of the TFT substrate and the color filter substrate. If the electrophoretic sheet has an elongated tape shape, only parts on which the capsules 111 of the electrophoretic layer 110 are uniformly formed may be cut.

FIG. 4E, FIG. 4F, FIG. 4G, FIG. 4H, FIG. 4I, and FIG. 4J are views showing a process of manufacturing an electrophoretic display device according to an exemplary embodiment of the present invention.

Referring to FIG. 4E, an electrophoretic layer 110, an electrophoretic sheet 100 including the first and second adhesive layers 131 and 132 and the first and second release sheets 121 and 122, and the TFT substrate 200 are arranged. Referring to FIG. 4F, the first release sheet 121 is released from the first adhesive layer 131 to expose one side of the first adhesive layer 131. Referring to FIG. 4G, the TFT substrate 200 and the electrophoretic sheet 100 are arranged between two rollers 500 to implement roll-to-roll lamination. Alternatively, vacuum lamination may be implemented by putting the TFT substrate 200 and the electrophoretic sheet 100 into a vacuum chamber.

Referring to FIG. 4H, the electrophoretic sheet 100 attached to the TFT substrate 200 is arranged corresponding to the color filter substrate 300. Referring to FIG. 4I, the second release sheet 122 is detached from the second adhesive layer 132 to expose one side of the second adhesive layer 132. Referring to FIG. 4J, the color filter substrate 300 and the electrophoretic sheet 100 attached to the TFT substrate 200 are arranged between two rollers 500 to perform roll-to-roll lamination. Alternatively, the color filter substrate 300 and the electrophoretic sheet 100 may be vacuum laminated in a vacuum chamber. Unlike the above process, the electrophoretic sheet 100 may be first attached to the color filter substrate 300 and then assembled with the TFT substrate 200.

The electrophoretic display device formed in the above manner reduces the unnecessary waste of the electrophoretic sheet 100 by attaching an electrophoretic sheet 100 of an appropriate size to the TFT substrate 200 and the color filter substrate 300.

Moreover, since the capsules 111 of the electrophoretic layer 110 are evenly coated, color gamut may be improved.

As described above, capsules of an electrophoretic layer are evenly coated to improve coating uniformity and light reflective quality. Since the electrophoretic sheet having uniformly coated capsules is assembled with the TFT substrate and the color filter substrate, color gamut may be improved.

In manufacturing an electrophoretic display device including an electrophoretic sheet, the electrophoretic layer may be evenly coated and the electrophoretic sheet may be easily attached to other materials. Furthermore, only the electrophoretic sheet of a necessary amount can be manufactured, waste of a material is prevented and a manufacturing process is simplified.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. A method of manufacturing an electrophoretic sheet, comprising:
forming a first adhesive layer on a first release sheet;
forming a second adhesive layer on a second release sheet;
forming an electrophoretic layer on one side of the first adhesive layer; and
coupling the electrophoretic layer to the second adhesive layer.

2. The method of claim 1, wherein forming the first adhesive layer comprises depositing an adhesive on the first release sheet and curing the adhesive, and wherein forming the second adhesive layer comprises depositing the adhesive on the second release sheet and curing the adhesive.

3. The method of claim 1, wherein forming the electrophoretic layer comprises depositing a capsule and a binder on one side of the first adhesive layer and curing the capsule and the binder, the capsules comprising charged pigment particles.

4. The method of claim 3, wherein the capsules are deposited in a single layer structure.

5. The method of claim 1, wherein coupling the electrophoretic layer to the second adhesive layer comprises coupling the first release sheet and the second release sheet together by a roll-to-roll lamination method.

6. The method of claim 1, wherein coupling the electrophoretic layer to the second adhesive layer comprises coupling the first release sheet and the second release sheet together a vacuum lamination method.

7. A method of manufacturing an electrophoretic display device, comprising:
forming a first adhesive layer on a first release sheet;
forming a second adhesive layer on a second release sheet;
forming an electrophoretic layer on one side of the first adhesive layer;
coupling the electrophoretic layer to the second adhesive layer to form an electrophoretic sheet; and
arranging the electrophoretic sheet between a thin film transistor substrate and a color filter substrate.

8. The method of claim 7, wherein arranging the electrophoretic sheet between a thin film transistor substrate and a color filter substrate comprises:
detaching the first release sheet and the second release sheet from the first adhesive layer and the second adhesive layer, respectively; and
coupling the thin film transistor substrate and the color filter substrate.

9. The method of claim 8, wherein arranging the electrophoretic sheet between a thin film transistor substrate and a color filter substrate comprises a roll-to-roll lamination method.

10. The method of claim 8, wherein arranging the electrophoretic sheet between a thin film transistor substrate and a color filter substrate comprises a vacuum lamination method.

11. An electrophoretic sheet, comprising:
an electrophoretic layer comprising black charged pigment particles and white charged pigment particles;
a first adhesive layer and a second adhesive layer arranged at a first surface and a second surface of the electrophoretic layer, respectively; and
a first release sheet and a second release sheet attached to the first adhesive layer and the second adhesive layer, respectively.

12. The electrophoretic sheet of claim 11, wherein the first adhesive layer and the second adhesive layer are transparent.

13. The electrophoretic sheet of claim 12, wherein the first adhesive layer and the second adhesive layer comprise an acrylic- or epoxy-based adhesive material.

14. The electrophoretic sheet of claim 11, wherein the first release sheet and the second release sheet each comprise one of polyethylene (PE), polyethylene terephthalate (PET), and polyethylene naphthalate (PEN).

15. An electrophoretic display device, comprising:
a thin film transistor substrate comprising a thin film transistor and a pixel electrode;
a color filter substrate facing the thin film transistor substrate, the color filter substrate comprising a color filter and a common electrode; and
an electrophoretic layer disposed between the thin film transistor substrate and the color filter substrate;
wherein the electrophoretic layer comprises a capsule filled with black charged pigment particles and white charged pigment particles, the electrophoretic layer being disposed between the thin film transistor substrate and the color filter substrate and between a first adhesive layer and a second adhesive layer arranged at opposite sides of the electrophoretic layer.

16. The electrophoretic display device of claim 15, wherein the first adhesive layer and the second adhesive layer are transparent.

17. The electrophoretic display device of claim 15, wherein the first adhesive layer and the second adhesive layer comprise an acrylic- or epoxy-based adhesive material.
